(19) United States
(12) Patent Application Publication
(10) Pub. No.: US 2006/0080305 A1
(43) Pub. Date: Apr. 13, 2006

(54) Accuracy of data harvesting

(76) Inventors: Heath Dill, Lowell, MA (US); Noel Dill, Bolton, MA (US)

Correspondence Address: Mark J. Pandiscio;Pandiscio & Pandiscio, P.C., 470 Totten Pond Road, Waltham, MA, 02451, US

(21) Appl. No.: 11/248,538

(22) Filed: Oct. 12, 2005

Related U.S. Application Data
(60) Provisional application No. 60/618,506, filed on Oct. 13, 2004.

(51) Int. Cl. G06F 17/30

(52) U.S. Cl. 707/3

(57) ABSTRACT

A method for searching a collection of documents, comprising: providing a document; providing a keyword associated with that document; certifying the relevance of the keyword to that document; and making the certified keyword available to a search engine. A database system comprising: a plurality of documents; at least one keyword associated with each of the plurality of documents, wherein the keyword has been certified for relevance to its associated document; and a search engine for searching the certified keywords. A database system comprising: a plurality of documents; a set of keyword tags, each of which is associated with an indication of either the content of a document, or its relevance to certain search engine queries, or both; keyword tags associated with each of the plurality of documents, wherein the tag has been associated with the document according to the preference of a user; and making the tags available to a search engine. A method for searching a collection of documents, comprising: providing a document; associating a tag with each of the plurality of documents, whereby the tag is associated with each document by a user and associates an attribute to that document; and making the tag available to a search engine.

### REFERENCE TO PENDING PRIOR PATENT APPLICATION

This patent application claims benefit of pending prior U.S. Provisional Patent Application Ser. No. 60/618,506, filed Oct. 13, 2004 by Heath Dill et al. for DISTRIBUTED INFORMATION STORAGE SYSTEM AND ITS POTENTIAL APPLICATIONS TO RESUME/JOB MATCHING AND OTHER ONLINE SERVICES (Attorney's Docket No. DILL-1 PROV), which patent application is hereby incorporated herein by reference.

### FIELD OF THE INVENTION

This invention relates to data harvesting in general, and more particularly to systems and methods for increasing the utility and accuracy of data harvesting.

### BACKGROUND OF THE INVENTION

With the advent of the World Wide Web (the “Web”), universal self-publishing has become a reality. In essence, anyone with information or data to share can do so, by simply placing that data in publicly-available Web pages. Search engines crawl the Web, digesting these Web pages and cataloging their content. Searchers then use those search engines to find the data available on the Web and harvest that data.

While the Web has proven to be enormously successful, it also has something of an “Achilles heel” when it comes to data harvesting. More particularly, while many different search engines are currently available for locating data on the Web, and while these various search engines use a wide variety of different methodologies to digest the Web pages and catalog their content, all of the search engines tend to share a common feature: they operate by capturing the text provided by the Web page and then cataloging that text. Thus, the search engine is dependent upon the text provided by the publisher of the Web page.

This dependency on publisher-provided text can lead to several problems in data harvesting.

First, unless the publisher of the Web page has carefully considered the specific search algorithms used by the various search engines, the Web page may not lend itself to easy discovery. In other words, if the publisher of the Web page fails to provide a specific term in the Web page, a search engine searching for that specific term may fail to identify the Web page as being relevant to that search query. Furthermore, even if the publisher of the Web page provides that specific term with the Web page, but fails to use that term with sufficient frequency, the search engine may rank that Web page too “low” on a search report for that Web page to be given serious consideration by the searcher.

Second, the system is highly susceptible to deliberate manipulation by Web page publishers who wish to “trick” the search engine into identifying a Web page as meeting certain content criteria when, in fact, that Web page does not. Thus, for example, a Web page publisher may—intentionally, and misleadingly—use terms such as “White House” and “President” in its Web page, while actually providing pornographic subject matter. Or the publisher of the Web page may use the term “free” in conjunction with its products when, in fact, the Web page publisher does not offer any free products at all.

Third, filtering and page ranking is controlled by the search engine's page catalog and page ranking algorithms and methods. While a user may manage the results of their searches through clever search parameters, they are ultimately accessing the entire page catalog of the search engine, and are at the mercy of the search engine's algorithms and methods for the interpretation of those search parameters. Search engines cannot easily be “customized” by a user to filter the results of their queries according to arbitrary conditions, or to restrict those results to certain frequently used web sites. Bookmarks and static Web pages can address these problems to a point, but bookmarks are typically limited to a single computer, and maintaining a Web page containing bookmarks is unwieldy, and easily managed only by a single user.

Fourth, it is difficult for groups of users to share preferences for their searches. Use of “wiki”-style sites, easily editable by multiple users, has made some headway in the realm of management of page lists across multiple users, but establishing their functionality requires some expertise, and their use is generally limited to storing links. They do not provide a broader portal to the entire set of pages that a search engine can cover.

The present invention is intended to address one or more of the foregoing problems.

### SUMMARY OF THE INVENTION

These and other objects are addressed by the provision and use of the present invention, which comprises, in one preferred form of the invention, a method for searching a collection of documents, comprising:

providing a document;

providing a keyword associated with that document;

certifying the relevance of the keyword to that document; and

making the certified keyword available to a search engine.

In another form of the invention, there is provided a database system comprising:

a plurality of documents;

at least one keyword associated with each of the plurality of documents, wherein the keyword has been certified for relevance to its associated document; and

a search engine for searching the certified keywords.

In another form of the invention, there is provided a database system comprising:

a plurality of documents;

a set of keyword tags, each of which is associated with an indication of either the content of a document, or its relevance to certain search engine queries, or both;

keyword tags associated with each of the plurality of documents, wherein the tag has been associated with the document according to the preference of a user; and

making the tags available to a search engine.

In another form of the invention, there is provided a method for searching a collection of documents comprising:

providing a document;

associating a tag with each of the plurality of documents, whereby the tag is associated with each document by a user and associates an attribute to that document; and

making the tag available to a search engine.

### BRIEF DESCRIPTION OF THE DRAWINGS

These and other objects and features of the present invention will be more fully disclosed or rendered obvious by the following detailed description of the preferred embodiments of the invention, which are to be considered together with the accompanying drawings wherein like numbers refer to like parts, and further wherein:

FIG. 1 is a schematic view showing a first preferred embodiment of the present invention;

FIG. 2 is a schematic view showing a second preferred embodiment of the present invention; and

FIG. 3 is an example showing a use case of a third preferred embodiment of the present invention.

### DETAILED DESCRIPTION OF THE INVENTION

The present invention provides a new system for increasing the accuracy and relevance of data harvesting, by ensuring the accuracy of the text used by the search engine when identifying relevant Web pages in response to a search query.

Among other things, the present invention comprises a set of technological and business processes which provide standards regarding the content of Web pages and hence improves the results of search engine queries.

### DEFINITIONS

For the purposes of the present invention, the following terms may be considered to have the following definitions:

“Search Engine”—a search engine that functions on the Internet, or on a similar set of documents, sites and/or Web pages;

“Search Engine Provider”—a company or other entity that manages, runs, and/or implements a Search Engine;

“Document Set”—one or more documents, one or more Web pages, and/or one or more Web sites;

“Document Owner”—a person, business or other entity who/which controls/owns a document set to which the search engine can refer when generating results to a search query (e.g., a Web page publisher);

“Keyword”—a key word, phrase or other piece of information that a document owner wishes to have “certified”;

“Certified Keyword”—a key word, phrase or other piece of information that a document owner has had “certified”.

“Tag”—a key word, phrase, or other piece of information that a search engine user wishes to have associated with a document.

### CERTIFICATION

In accordance with the present invention, there is provided a system for certifying keywords associated with a Document Set (e.g., a Web page), so as to ensure that those keywords accurately relate to the subject matter of the Web page. As a result, when a search engine conducts a search query using the certified keywords, the accuracy of data harvesting is significantly increased.

### SEARCH ENGINE CERTIFICATION

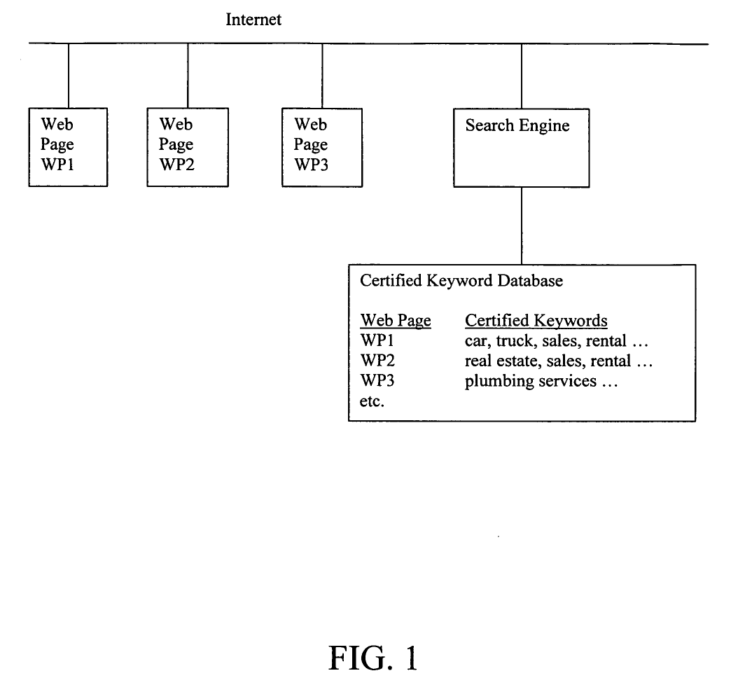

In one form of the invention, and looking now at FIG. 1, keyword certification is provided by the search engine provider, and the certified keywords are maintained in a database run by the search engine.

More particularly, with this form of the invention, the system is preferably implemented as follows:

(1) a Document Owner requests, from a Search Engine Provider, that a Document Set available to the Search Engine Provider be “certified” with one or more Keywords (the Keywords being certified are preferably proposed by the Document Owner; however, the Keywords being certified may also, or alternatively, be proposed by the Search Engine Provider);

(2) the Search Engine Provider verifies that the requested Keywords meet the Search Engine Provider's standards for acceptable content, applicability and relevance to the indicated Document Set, and other standards to which the Search Engine Provider may require adherence; and

(3) the Search Engine Provider and Document Owner enter into an agreement by which the Search Engine Provider agrees that the indicated Document Set will be marked, in some way, as having its content certified for accuracy and relevance to the requested Keywords. In other words, the Document Set will be associated with one or more Certified Keywords—and since these Keywords have passed the certification process, there is a high degree of confidence that the Certified Keywords accurately reflect the Document Set.

Preferably, the Document Owner also agrees to maintain the relevance and accuracy of those Keywords to the indicated Document Set, so as to ensure the continued reliability of the keyword certification. The agreement between the Document Owner and the Search Engine Provider may consist of financial terms, terms of service, duration, altering of duration, adding and/or removing Certified Keywords, altering a Document Set's scope or content, ongoing determination of accuracy and relevance, and other terms and conditions necessary to a business model using Certified Keywords.

### CERTIFIED KEYWORD SEARCHING

Once the Document Owner has had a Document Set certified with one or more Keywords, the Certified Keywords can then be used to provided certified searches, i.e., searches conducted using the highly reliable Certified Keywords.

Thus, the Search Engine Provider may provide certified searches, whereby only certified Document Sets are queried, and zero or more query parameters may be indicated as requiring or preferring a match to a Certified Keyword, thus returning Documents Sets for which those Keywords are certified.

The Search Engine Provider may adjust the relevance/ranking, in a query result set, of a Document Set with Certified Keywords, if any of the query parameters in a non-certified search using the Search Engine is determined to have relevance to a Certified Keyword relating to that Document Set.

### BENEFITS OF KEYWORD SEARCHING

The Certified Keyword model permits a Search Engine Provider to harness the strength of its Search Engine to guarantee that users querying the Search Engine receive results that are accurate and appropriate to their queries. For instance, a search looking for “online book sellers” might return bn.com, amazon.com, and other online booksellers who have an agreement to certify that phrase as a Keyword, whereas a traditional search engine query would rely on page rank, occurrences of the phrase in the Web pages in its index, and other imperfect heuristics. While these heuristics are increasing in their sophistication, the number of queries that return many inaccurate results is still vast.

Among other things, the Certified Keyword model permits the following:

(i) Specific Accuracy In Searching. A user searching for “replacement spa parts” and “online purchase” may have significant difficulty searching through the thousands of results typically generated by a conventional Search Engine (i.e., a Search Engine not using Certified Keywords), but in order to find sites that actually sell the desired items, a Certified Keyword would enable the user to quickly and easily cull the most relevant results, since the certification process could ensure that those Keywords only match those Document Sets (i.e., Web sites, in this example) that sell replacement spa parts online.

(ii) Refinement Of Searches. A user searching certified sites for “replacement spa parts” and “online purchase” might be shown, in the result set of their query, a list of Certified Keywords that the Search Engine has identified (through some process, manual or automated) as brand names, thus very visibly refining their options without the tedium and potential inaccuracy of modifying the query itself—the list of refinements is a set of Certified Keywords known to the Search Engine, and thus is guaranteed to give an accurate refinement.

(iii) Lexical Searching. A user may specify “business development” when searching for jobs online. If an online job posting site has “business development” in its constituent resumes, it may refer either to “sales” or “executive” business development, which are lexically similar but quite different. In this case, it would be possible to add “executive” as a search term, but even better is to add “executive/business development” as a 2-part lexical substitution: if the Certified Keyword process is configured to permit this sort of hierarchical search, then the accuracy of the search moves beyond simple Certified Keyword matching.

(iv) Locale Specific Searching. With the aforementioned lexical searches, or some equivalent method, it becomes possible to specify the locale of certified keywords. For instance, a brick-and-mortar retailer with a limited Web presence may be looking strictly to attract customers to its location. If that location is in Boston, Mass., it may specify its locale as “USA/Massachusetts/Boston”, or even “USA/Massachusetts/Boston/02110/Boylston Street”, which would enable searchers to clarify the physical location of their intended results to varying degrees of accuracy.

(v) Brand Specific Searching. With the aforementioned lexical searches, the searcher may specify that a search result may apply only to particular brands, trademarks, or other commercial identifiers.

(vi) A set of novel business models are established using the aforementioned Certified Keywords.

### KEYWORDS FROM DOCUMENT OWNER; KEYWORDS FROM SEARCH ENGINE PROVIDER

In the foregoing description, the Keywords are generated by the Document Owner and presented to the Search Engine Provider for certification. However, in another form of the invention, the Search Engine Provider may generate a Keyword (either in addition to Keywords proposed by the Document Owner or as an alternative to Keywords being proposed by the Document Owner) and certify the same.

### THIRD PARTY CERTIFICATION

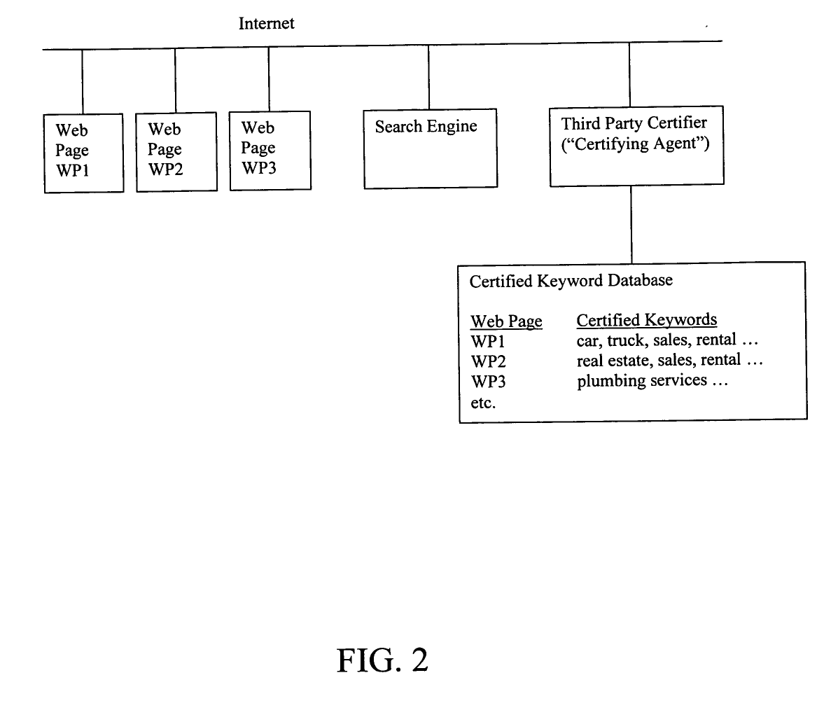

In another form of the invention, and looking now at FIG. 2, Keyword certification may be provided by a third party (i.e., a “Certifying Agent”) as opposed to certification by the Search Engine Provider, and the Certified Keywords maintained in a database administered or managed by the Certifying Agent, with that database being made available to a Search Engine.

Several Certifying Agents may be available to a customer wishing to certify Keywords, with options for selecting one or several Agents according to the user's preference. In the case that several Certifying Agents are available, it may be possible for a searcher to indicate which Certifying Agents are to be included in their searches. It may also be possible to have the results of the search include information indicating with which Certifying Agent the Keywords were certified.

### TAGGING

In another form of the invention, a user may “tag” a document with some identifier. This identifier may be available for searching by any user, or some subset of users, of the search engine. A tag is specified by the user—it may indicate a value or identifier to be associated with the document, the desire to include or exclude the document from the search engine results of users, or some other attribute of the document. Tags may be certified, as per certified keywords, but certification is not mandatory for tagging.

Among other things, the ability to tag documents permits the following:

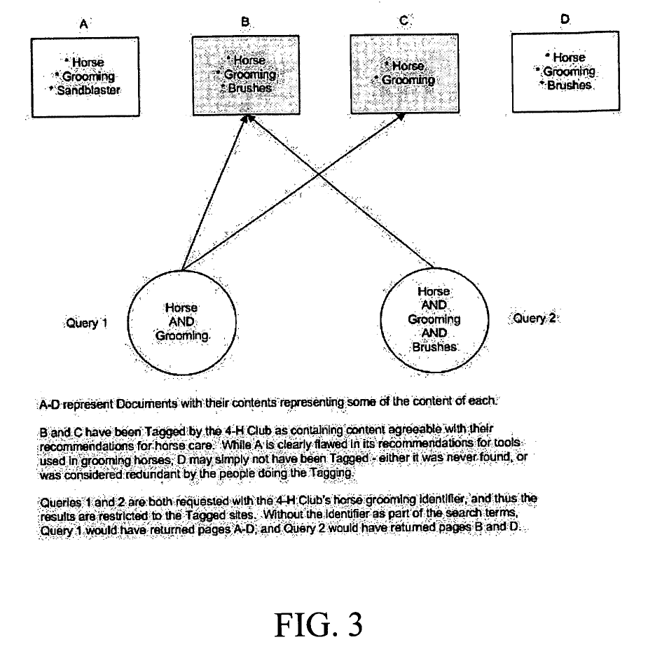

(i) Group Affiliation. Now looking at FIG. 3, members of some group or organization may tag documents to indicate that those documents are associated with that group. If the leadership of the 4-H club wishes to indicate a set of Web sites with widely-accepted instructions for horse care, they may tag those sites. Members of the 4-H club could then, through some method of identification to the search engine (a cookie, authentication, or other identification method), see their search results for relevant searches restricted to only the sites recommended by their leadership via tagging.

In another instance, if a software employer wishes to have their entire company tag sites with technical details relevant to the company's operation, they may permit open tagging by the entire company, and permit their company to search within the tagged documents. If the employer wishes to verify that the tagged sites are actually relevant to the company's operation, there may be a workflow whereby tags are confirmed and accepted or denied according to a subset of the company's employees before being made available in the results from the search engine.

(ii) Private Site Lists. If an instructor at a college wishes for his students to have access to a set of Web pages for their studies, but does not wish for that set of pages to be publicly accessible, perhaps to students planning on taking the same course in a subsequent year, they may set up a private site list of tagged sites, and enable only their current students, through some authentication/identification mechanism, to search with those documents.

(iii) Online Scavenger Hunt. An organization may hold an online scavenger hunt, or similar event, by requiring people or teams to find sites with certain attributes. For instance, if Team A and Team B are required to find a Web site with a picture of a beardless Abraham Lincoln, each will be given a unique identifier with which they may tag such a site. The organizer of the hunt will then be able to verify that the teams have found the site if the appropriate tag has been set on that web page.

(iv) Content Filters. Consider an organization dedicated to making pornography inaccessible to minors. While it is difficult for even a small number of people to find all pornographic sites, a broad organization may be able to apply far greater coverage to the many such sites, tagging those sites for denial from search engine results on their own computers. Any user wishing to filter their results so would be able to enable a cookie or other authentication mechanism, or to have operating system or browser integration of the filtering, such that sites tagged as having objectionable content (as determined by the anti-pornography organization) would not be returned in search engine results, or in the case of browser or operating system integration, possibly be made inaccessible entirely.

Content filters could also be positive—enabling certain sites to be marked as legitimate (or, perhaps, an organization dedicated to cataloguing pornographic sites for easier access would do precisely the opposite of the above example).

### NON-WEB APPLICATIONS

It should be appreciated that the present invention is not limited to Web applications. Rather, the present invention can be implemented in any situation where an individual or entity wishes to make information or data available to a searcher, and the searcher wishes to have Certified Keywords associated with that information or data so as to enhance the accuracy of data harvesting.

### FURTHER MODIFICATIONS

It is to be understood that the present invention is by no means limited to the particular constructions herein disclosed and/or shown in the drawings, but also comprises any modifications or equivalents within the scope of the invention.

What is claimed is:

1. A method for searching a collection of documents, comprising:
providing a document;
providing a keyword associated with that document;
certifying the relevance of the keyword to that document; and
making the certified keyword available to a search engine.

2. A method according to claim 1 wherein the keyword is provided by the same party that provides the document.

3. A method according to claim 1 wherein the keyword is provided by the same party that certifies the relevance of the keyword to the document.

4. A method according to claim 1 wherein the keyword is certified by the same party that provides the search engine.

5. A method according to claim 1 wherein the keyword is certified by a party different from the party that provides the search engine.

6. A database system comprising:
a plurality of documents;
at least one keyword associated with each of the plurality of documents, wherein the keyword has been certified for relevance to its associated document; and
a search engine for searching the certified keywords.

7. A database system comprising:
a plurality of documents;
a set of keyword tags, each of which is associated with an indication of either the content of a document, or its relevance to certain search engine queries, or both;
keyword tags associated with each of the plurality of documents, wherein the tag has been associated with the document according to the preference of a user; and
making the tags available to a search engine.

8. A method for searching a collection of documents comprising:
providing a document;
associating a tag with each of the plurality of documents, whereby the tag is associated with each document by a user and associates an attribute to that document; and
making the tag available to a search engine.
